(19) United States
(12) Patent Application Publication
(10) Pub. No.: US 2022/0049837 A1
(43) Pub. Date: Feb. 17, 2022

(54) OUTPUT LIGHT ADJUSTING DEVICE AND METHOD

(71) Applicant: Sharp Fukuyama Laser Co., Ltd., Fukuyama City (JP)

(72) Inventors: Shin ITOH, Fukuyama City (JP); KATSUSHIGE MASUI, Fukuyama City (JP); PETER JOHN ROBERTS, Oxford (GB)

(21) Appl. No.: 17/396,999

(22) Filed: Aug. 9, 2021

(30) Foreign Application Priority Data
Aug. 17, 2020 (JP) 2020-137568

(51) Int. Cl. F21V 14/06; F21V 5/04

(52) U.S. Cl. CPC F21V 14/06; F21V 5/04

(57) ABSTRACT

An output light adjusting device for adjusting a degree of collimation of first output light emitted from a light source module comprises a first image obtainer that obtains a first image of second output light output from a condenser, the condenser receiving the first output light, the first image being obtained at a position at which a length of a path of the second output light output from the condenser matches a first distance, the first distance being a distance from the condenser to a near position; and a second image obtainer that obtains a second image of the second output light at a position at which the length of the path of the second output light output from the condenser matches a second distance, the second distance being a distance from the condenser to a far position.

### BACKGROUND

### 1. Field

The present disclosure relates to an output light adjusting device for adjusting the degree of collimation of light emitted from a light source module or for making the degree of collimation of light adjustable, and also to an output light adjusting method for adjusting the degree of collimation of light emitted from a light source module.

### 2. Description of the Related Art

Hitherto, adjustments of the angle of an optical axis and the degree of collimation of light emitted from a light source are performed. An example of such an adjustment technology is disclosed in Japanese Patent No. 4656880. In the technology disclosed in this publication, a parallel beam of light emitted from an optical pickup is split into first parallel light and second parallel light. The first parallel light is concentrated by a first condenser, while the second parallel light is concentrated by a second condenser. A beam spot of the first parallel light concentrated by the first condenser is imaged. The defocusing state of the second parallel light is changed by shifting the second condenser on the optical axis by every predetermined amount, and the resulting beam spot of the second parallel light is imaged. With this arrangement, the properties of the optical pickup can be measured with a simple structure, and the optical pickup can be adjusted speedily.

In an aspect of the present disclosure, the degree of collimation of light emitted from a light source module is adjusted by using a method different from the technology of the above-described publication. It is desirable to speedily and highly precisely adjust the degree of collimation of light emitted from a light source module with a simple method.

### SUMMARY

According to an aspect of the disclosure, there is provided an output light adjusting device for adjusting a degree of collimation of first output light emitted from a light source module or for making the degree of collimation of the first output light adjustable. The light source module is a subject to be adjusted. The output light adjusting device includes first and second image obtainers. The first image obtainer obtains a first image of second output light output from a condenser, the condenser receiving the first output light, the first image being obtained at a position at which a length of a path of the second output light output from the condenser matches a first distance, the first distance being a distance from the condenser to a near position. The second image obtainer obtains a second image of the second output light at a position at which the length of the path of the second output light output from the condenser matches a second distance, the second distance being a distance from the condenser to a far position. The near position is a position which is close to the condenser on an optical axis of the condenser and which is separated from a preset reference light-concentration position of the second output light by a predetermined distance. The far position is a position which is located at a side opposite the near position on the optical axis with the reference light-concentration position interposed therebetween and which is separated from the reference light-concentration position by a predetermined distance.

According to an aspect of the disclosure, there is provided an output light adjusting method for adjusting a degree of collimation of first output light emitted from a light source module. The light source module is a subject to be adjusted. The output light adjusting method includes: comparing a size of a first image of second output light and a size of a second image of the second output light with each other, the first image of the second output light being obtained at a position at which a length of a path of the second output light output from a condenser, the condenser receiving the first output light, matches a first distance, the first distance being a distance from the condenser to a near position, the second image of the second output light being obtained at a position at which the length of the path of the second output light output from the condenser matches a second distance, the second distance being a distance from the condenser to a far position; and adjusting a position of an optical component of the light source module so that a degree of matching between the size of the first image and the size of the second image is judged to be included within a predetermined range as a result of comparing the size of the first image and the size of the second image. The near position is a position which is close to the condenser on an optical axis of the condenser and which is separated from a preset reference light-concentration position of the second output light by a predetermined distance. The far position is a position which is located at a side opposite the near position on the optical axis with the reference light-concentration position interposed therebetween and which is separated from the reference light-concentration position by a predetermined distance.

### BRIEF DESCRIPTION OF THE DRAWINGS

FIG. 1 shows a schematic view and a graph for explaining an output light adjusting device according to a first embodiment;

FIG. 2 is a block diagram illustrating an example of the output light adjusting device;

FIG. 3 is a block diagram illustrating another example of the output light adjusting device;

FIG. 4 is a table illustrating the size of an image of light at each of a near position and a far position in accordance with the mode of first output light;

FIG. 5 is a flowchart illustrating an example of processing executed by the output light adjusting device;

FIG. 6 shows a schematic view and a graph for explaining a comparative example of the output light adjusting device of the first embodiment;

FIG. 7 shows a schematic view and a graph for explaining another comparative example of the output light adjusting device of the first embodiment;

FIG. 8 is a schematic view illustrating an example of an output light adjusting device according to a second embodiment;

FIG. 9 is a schematic view illustrating an example of an output light adjusting device according to a third embodiment;

FIG. 10 illustrates an arrangement example of first and second beam profilers in the output light adjusting device of the first embodiment when the degree of collimation is adjusted to make first output light become a preset convergent beam of light;

FIG. 11 shows schematic views illustrating modified examples of a light source module;

FIG. 12 shows schematic views illustrating modified examples of a light source module; and

FIG. 13 is a schematic view illustrating a modified example of a light source module.

### DESCRIPTION OF THE EMBODIMENTS

### First Embodiment

A first embodiment of the disclosure will be described below in detail.

### (Output Light Adjusting Device)

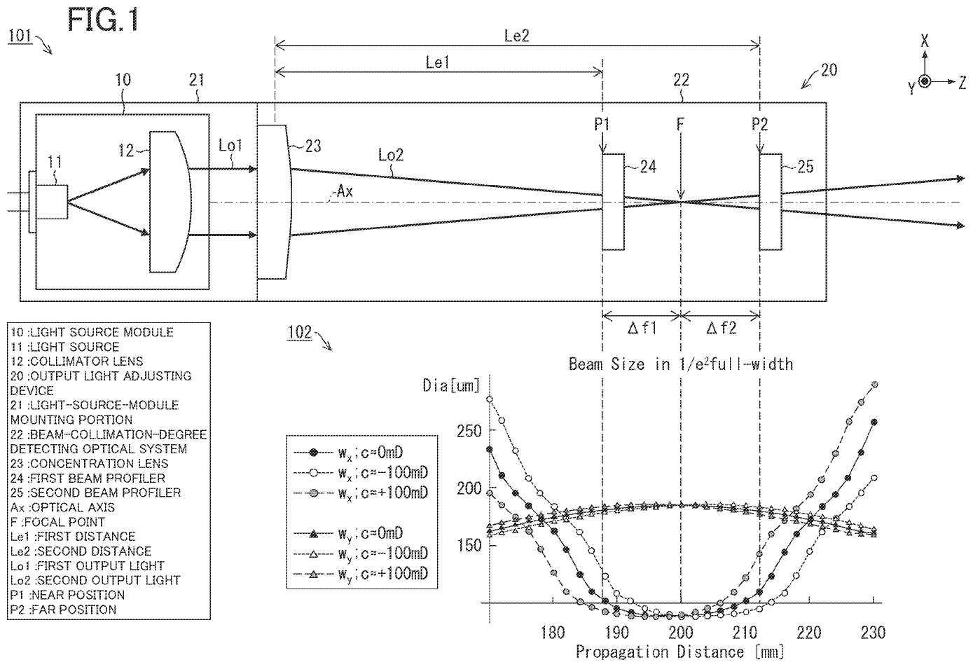

FIG. 1 shows a schematic view 101 and a graph 102 for explaining an output light adjusting device 20 according to the first embodiment. The schematic view 101 illustrates an example of the output light adjusting device 20. The output light adjusting device 20 adjusts the degree of collimation of light emitted from a light source module 10. Hereinafter, light emitted from a light source module 10 will be called first output light Lo1.

As shown in the schematic view 101, the output light adjusting device 20 largely includes a light-source-module mounting portion 21 and a beam-collimation-degree detecting optical system 22. The light-source-module mounting portion 21 is a portion on which a light source module 10 is removably mounted. That is, the light source module 10 is attachable to and detachable from the output light adjusting device 20. The beam-collimation-degree detecting optical system 22 is an optical system (measurement system) for measuring (detecting) the degree of collimation of the first output light Lo1 emitted from the light source module 10.

### (Light Source Module)

The light source module 10 is a light emitting device, which is a subject to be adjusted (measured) by the output light adjusting device 20 (hereinafter may also be simply called a subject). The light source module 10 includes at least a light source 11 and a collimator lens 12. The light source 11 generates light to be emitted to the exterior of the light source module 10. In the first embodiment, the light source 11 is a laser light source, such as a laser diode, which emits laser light. The light source 11 may be another type of light source, such as a light emitting device (LED).

The collimator lens 12 is a lens that narrows light generated in and emitted from the light source 11. After passing through the collimator lens 12, light is output from the light source module 10 as the first output light Lo1. The collimator lens 12 is used for adjusting the degree of collimation of the first output light Lo1.

A desired degree of collimation of the first output light Lo1, which is a target value (typical value), is determined by the purpose of use of the light source module 10. In the first embodiment, the target value is set as a degree of collimation of the first output light Lo1 to make the first output light Lo1 become a parallel beam of light. Depending on the purpose of use of a light source module 10, however, the target value may be set as a desired degree of collimation to make the first output light Lo1 become a divergent beam of light or a convergent beam of light.

### (Beam-Collimation-Degree Detecting Optical System)

The beam-collimation-degree detecting optical system 22 largely includes a condenser 23, a first beam profiler 24 (first image obtainer), and a second beam profiler 25 (second image obtainer).

The condenser 23 receives the first output light Lo1 emitted from the light source module 10 and concentrates it outside the light source module 10. More specifically, the condenser 23 concentrates the first output light Lo1 at a position forward (ahead) of the condenser 23 (in the +Z-axis direction) inside the beam-collimation-degree detecting optical system 22. For the sake of description, the first output light Lo1 having passed through the condenser 23 and being concentrated at a position forward of the condenser 23 will be called second output light Lo2.

As the condenser 23, any lens having light concentration properties may be used. For example, an achromatic lens, which restricts chromatic dispersion, may be used. If a white light source or multiple light sources 11 having different emission wavelengths are used as the light source 11, the use of an achromatic lens as the condenser 23 is suitable.

The distance from the condenser 23 to a near position P1 is set to be a first distance Le1. The near position P1 is a position close to the condenser 23 on the optical axis Ax of the condenser 23 and separated from a focal point F of the condenser 23 by a predetermined distance Δf1. The distance from the condenser 23 to a far position P2 is set to be a second distance Le2. The far position P2 is a position which is located at a side opposite the near position P1 on the optical axis Ax with the focal point F1 interposed therebetween and which is separated from the focal point F by a predetermined distance Δf2 (≅Δf1). In the first embodiment, the far position P2 is a position located symmetrically to the near position P1 with respect to the focal point F on the optical axis Ax.

As discussed above, in the first embodiment, as a desired degree of collimation, the degree of collimation of the first output light Lo1 to make the first output light Lo1 become a parallel beam of light is set. In the first embodiment, as a preset reference light-concentration position of the second output light Lo2, the position of the focal point F of the condenser 23 is set. That is, the reference light-concentration position of the second output light Lo2 is set for implementing a desired degree of collimation of the first output light Lo1. In second and third embodiments, too, as a desired degree of collimation, the degree of collimation of the first output light Lo1 to make the first output light Lo1 become a parallel beam of light is set.

The first beam profiler 24 captures a first image of the second output light Lo2 at a position at which the length of the path of the second output light Lo2 output from the condenser 23 matches the first distance Le1. In the first embodiment, the first beam profiler 24 captures the first image of the second output light Lo2 at the near position P1.

The second beam profiler 25 captures a second image of the second output light Lo2 at a position at which the length of the path of the second output light Lo2 matches the second distance Le2. In the first embodiment, the second beam profiler 25 captures the second image of the second output light Lo2 at the far position P2.

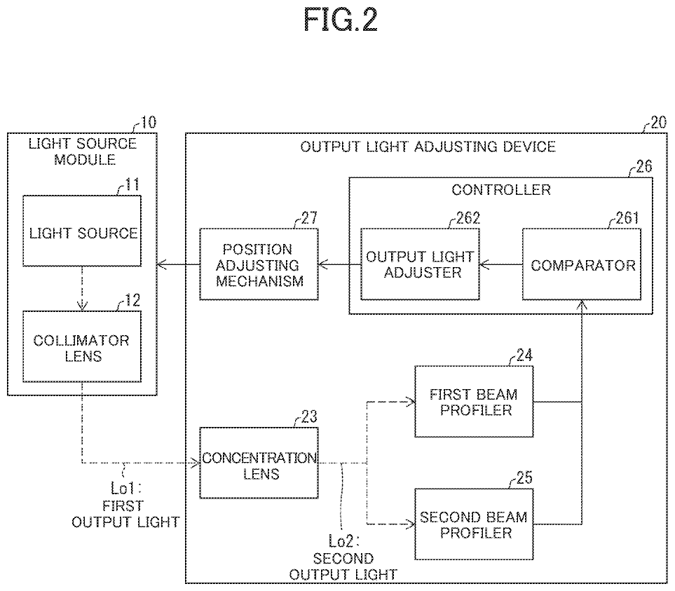

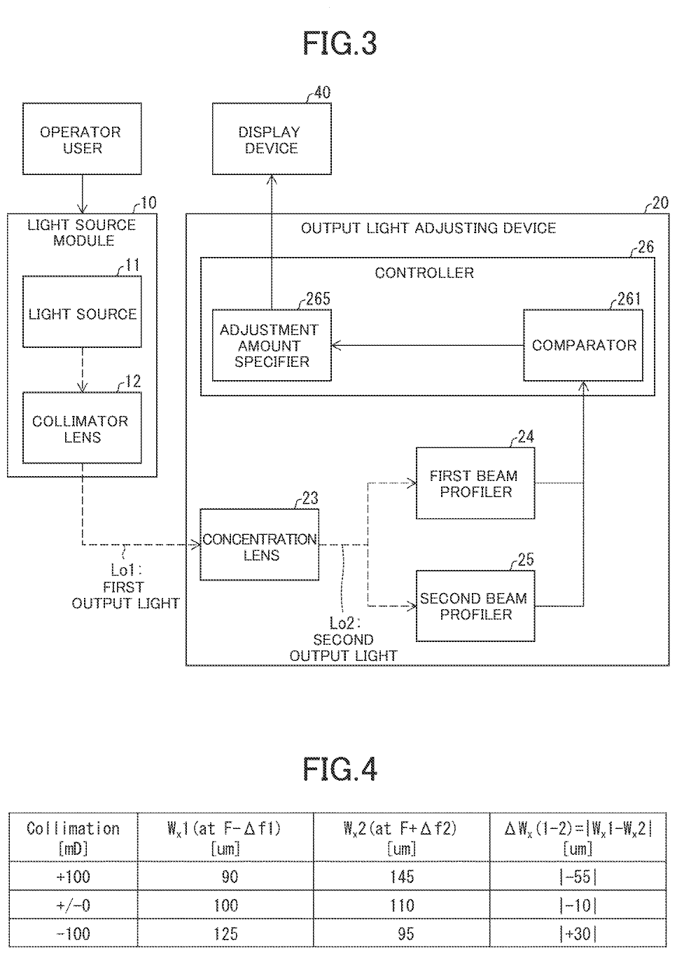

The first beam profiler 24 largely includes an imaging element that captures the first image and a measurement unit that measures the size (beam spot size) of the first image. The second beam profiler 25 largely includes an imaging element that captures the second image and a measurement unit that measures the size (beam spot size) of the second image. Examples of the imaging element are a charge-coupled device (CCD) and a complementary metal-oxide-semiconductor (CMOS). Measurement data obtained by the measurement units of the first and second beam profilers 24 and 25 is sent to a controller 26 shown in FIG. 2 or 3.

In the first embodiment, the first beam profiler 24 is disposed at the near position P1, while the second beam profiler 25 is disposed at the far position P2. The first and second beam profilers 24 and 25 do not transmit light. Because of this property, in the state in which the first beam profiler 24 is disposed at the near position P1, the second beam profiler 25, which is located at the far position P2, is unable to capture the second image.

To address this issue, in the first embodiment, the first beam profiler 24 is disposed at the near position P1 at least when capturing the first image, but it is moved out of the optical axis Ax when the second beam profiler 25 captures the second image at the far position P2. The second beam profiler 25 is disposed at the far position P2. The second beam profiler 25 may be fixed at the far position P2 or may be movable as in the first beam profiler 24.

The output light adjusting device 20 may include a movement mechanism for shifting the first and second beam profilers 24 and 25. In this case, under the control of the controller 26, the movement mechanism places the first beam profiler 24 at the near position P1 and moves it out of the optical axis Ax. Likewise, the movement mechanism may place the second beam profiler 25 at the far position P2 and move it out of the optical axis Ax. If the output light adjusting device 20 does not include a movement mechanism, an operator user may place the first beam profiler 24 at the near position P1 and remove it from the near position P1. The operator user may also place the second beam profiler 25 at the far position P2 and remove it from the far position P2.

Instead of the first and second beam profilers 24 and 25, an imaging element that captures the first image may be disposed at the near position P1, and an imaging element that captures the second image may be disposed at the far position P2. In this case, a function for controlling the imaging elements may be provided in the output light adjusting device 20 or may be implemented by a control device that connects the output light adjusting device 20 and the imaging elements so as to allow them to communicate with each other.

FIG. 2 is a block diagram illustrating an example of the output light adjusting device 20. As shown in FIG. 2, in addition to the above-described first and second beam profilers 24 and 25, the output light adjusting device 20 includes a controller 26, which centrally controls the output light adjusting device 20. The controller 26 largely includes a comparator 261 and an output light adjuster 262.

The comparator 261 compares the size of the first image captured by the first beam profiler 24 and the size of the second image captured by the second beam profiler 25 with each other. The comparator 261 sends a comparison result to the output light adjuster 262.

The output light adjuster 262 adjusts the position of an optical component of the light source module 10 so that the comparator 261 judges that the degree of matching between the size of the first image and that of the second image is included within a predetermined range. If the optical axis of light emitted from the light source 11 is the Z axis (see FIG. 1), the output light adjuster 262 adjusts the position of the light source 11 in the Z-axis direction or the position of the collimator lens 12 in the Z-axis direction. This can adjust the degree of collimation of the first output light Lo1.

The above-described predetermined range is a range of degrees of matching between the size of the first image and that of the second image when the first output light Lo1 is a parallel beam of light or is regarded as a parallel beam of light. The predetermined range is preset by experiment, for example. When the first output light Lo1 is or is regarded as a parallel beam of light, the beam waist position of the second output light Lo2 substantially coincides with the focal point F.

If the comparator 261 judges that the degree of matching between the size of the first image and that of the second image is outside the predetermined range, the output light adjuster 262 adjusts the position of the light source 11 or the collimator lens 12 in the Z-axis direction. For example, based on the sizes of the first and second images, the output light adjuster 262 calculates the focal point at which the second output light Lo2 output from the condenser 23 comes into focus, and calculates the amount of deviation of the position of this focal point from that of the ideal focal point F. The relationship between the amount of deviation and the amount by which the position of the light source 11 or the collimator lens 12 in the Z-axis direction is to be adjusted (hereinafter such an amount may also be called the amount of adjustment) is preset by experiment, for example. The output light adjuster 262 thus identifies the amount of adjustment by calculating the amount of deviation and adjusts the position of the light source 11 or the collimator lens 12 in the Z-axis direction by the identified amount of adjustment.

If the initial position of the light source 11 or the collimator lens 12 deviates from its ideal position by a considerable amount, the output light adjuster 262 may repeat the adjustment of the position of the light source 11 or the collimator lens 12 multiple times until the degree of matching between the size of the first image and that of the second image can be included within the predetermined range.

As shown in FIG. 2, the output light adjusting device 20 may include a position adjusting mechanism 27. In this case, the output light adjuster 262 sends data indicating the amount of adjustment to the position adjusting mechanism 27. Then, the position adjusting mechanism 27 can adjust the position of the light source 11 or the collimator lens 12 in the Z-axis direction. If the light source module 10 includes a mechanism equivalent to the position adjusting mechanism 27, the output light adjuster 262 sends data indicating the amount of adjustment to this mechanism, and the mechanism can make the above-described position adjustment.

Although the position of the light source 11 or the collimator lens 12 is adjusted in the Z-axis direction by the position adjusting mechanism 27, it may also be adjustable in the X-axis direction or the Y-axis direction.

The above-described position adjustment may be performed by an operator user. In this case, the output light adjusting device 20 functions as a device that makes the degree of collimation of the first output light Lo1 emitted from a light source module 10 adjustable. FIG. 3 is a block diagram illustrating another example of the output light adjusting device 20. An operator user may perform the above-described position adjustment by moving the light source 11 or the collimator lens 12 directly or by using a jig.

If an operator user carries out the above-described position adjustment, the controller 26 includes an adjustment amount specifier 265 instead of the output light adjuster 262, as shown in FIG. 3. The output light adjusting device 20 is connected to a display device 40 so that it can communicate with the display device 40. The adjustment amount specifier 265 executes the above-described processing executed by the output light adjuster 262 so as to specify the amount by which the Z-axis position of the light source 11 or the collimator lens 12 is to be adjusted. The adjustment amount specifier 265 sends data indicating the specified amount of adjustment to the display device 40, and the display device 40 presents the amount of adjustment to the operator user. The operator user adjusts the Z-axis position of the light source 11 or the collimator lens 12 by this amount of adjustment.

Instead of using the display device 40, the output light adjusting device 20 may include a display and display the amount of adjustment on the display. As a presenter device that presents the amount of adjustment, a sound output device, for example, may be used to present the amount of display, instead of the display device 40.

If an operator user carries out the above-described position adjustment, the output light adjusting device 20 may not necessarily include the position adjusting mechanism 27 shown in FIG. 2, or the light source module 10 may not necessarily include a mechanism equivalent to the position adjusting mechanism 27. Nevertheless, the operator user may perform the above-described position adjustment by operating the position adjusting mechanism 27 or this equivalent mechanism.

If the operator user performs the above-described position adjustment by checking the sizes of the first and second images, the controller 26 may not necessarily include the comparator 261 and the output light adjuster 262 shown in FIG. 2 or the comparator 261 and the adjustment amount specifier 265 shown in FIG. 3. In this case, the controller 26 may display image data indicating the first and second images and/or measurement data on the presenter device.

The operator user specifies the near position P1 and the far position P2, which will be discussed later, by using profiles of the second output light Lo2 obtained from a sample of a light source module 10, which serves as a reference light source module. This specifying processing may be executed by the controller 26, instead of the operator user.

### (Specifying of Near Position P1 and Far Position P2)

An approach to specifying the near position P1 and the far position P2 will be described below with reference to the graph 102 of FIG. 1 and the table of FIG. 4. The graph 102 of FIG. 1 illustrates examples of profiles of images of the second output light Lo2. Each profile indicates the size of an image of the second output light Lo2 on a plane perpendicular to the optical axis Ax. In the profile, the size of the image is indicated in accordance with the position of the second output light Lo2 on the optical axis Ax. The profile is measured in response to the first output light Lo1 incident on the condenser 23. The table of FIG. 4 shows the size of an image of the second output light Lo2 corresponding to the first output light Lo1 emitted from the light source module 10 at each of the near position P1 and the far position P2. More specifically, the size of the image shown in FIG. 4 is indicated in accordance with the mode of the first output light Lo1, that is, in accordance with whether the first output light Lo1 is a typical example of a parallel beam of light, a divergent beam of light, or a convergent beam of light.

In the graph 102 of FIG. 1, the horizontal axis indicates the distance (Propagation Distance [mm]) from the condenser 23 on the optical axis Ax. In this example, the optical axis Ax is the Z axis. The vertical axis indicates the diameter (Dia. [μm]) of the image of the second output light Lo2 in the X-axis direction and that in the Y-axis direction at individual positions on the optical axis Ax (Z axis). In the graph 102 of FIG. 1, the profile indicating the diameter in the X-axis direction is represented by Wx, and that in the Y-axis direction is represented by Wy. In this example, the size of the image of the second output light Lo2 is defined in the following manner. The distance between two points at which the intensity of the second output light Lo2 falls to 1/e² of the maximum intensity of the intensity distribution of the second output light Lo2 is defined as the diameter (Beam Size in 1/e² full-width) of the image. In this example, as the condenser 23, an achromatic lens having a focal length of 200 mm is used.

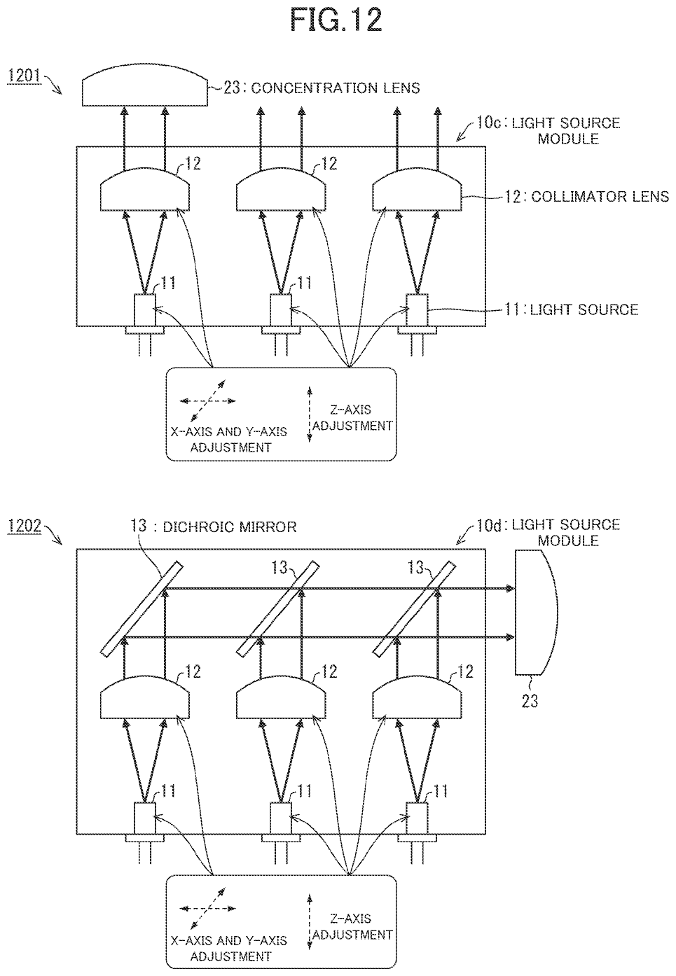

As stated above, an achromatic lens restricts chromatic dispersion. Using an achromatic lens as the condenser 23 can form the focal point F at substantially the same position regardless of the emission wavelength of the light source 11. That is, even if the light sources 11 included in light source modules 10 to be adjusted by the output light adjusting device 20 have different emission wavelengths, the focal point F is formed at substantially the same position by the use of an achromatic lens as the condenser 23. If a light source module 10 includes multiple light sources 11, as shown in FIG. 12, the focal point F is formed at substantially the same position by the use of an achromatic lens as the condenser 23. This means that the position of the focal point F and the near position P1 and the far position P2 corresponding to the focal point F are not required to be set for each light source 11. The output light adjusting device 20 or an operator user can thus adjust the degree of collimation of the first output light Lo1 while maintaining the focal point F, the near position P1, and the far position P2 at fixed positions.

In other words, when an achromatic lens is used as the condenser 23, the position of each of the first and second beam profilers 24 and 25 can be fixed at substantially the same position regardless of the wavelength of the first output light Lo1 incident on the condenser 23. Even when light sources 11 having different emission wavelengths are used, the output light adjusting device 20 or an operator user can easily make adjustment to the first output light Lo1 without changing the settings of the output light adjusting device 20. This allows the output light adjusting device 20 or the operator user to continuously adjust the first output light Lo1, thereby significantly reducing the time taken for the adjustment.

The graph 102 of FIG. 1 illustrates the profile of the image of the second output light Lo2 in accordance with the mode of the first output light Lo1, that is, whether the first output light Lo1 is a typical example of a parallel beam of light, a convergent beam of light, or a divergent beam of light. The individual profiles are determined in advance by experiment or computer simulation, based on the optical properties of the light source module 10 and/or the output light adjusting device 20, such as the emission wavelength of the light source 11 and the properties of the collimator lens 12 and the condenser 23.

In the graph 102 of FIG. 1 and the table of FIG. 4, the diopter (D) is used as the index indicating the degree of collimation of light to show how much light is collimated, converges, or diverges. Normally, the diopter is a unit of measurement of the optical power of a spectacle lens. To distinguish the diopter indicating the degree of collimation from that for the optical power of a spectacle lens, in the specification, the index indicating the degree of collimation of light is represented by “C”, which is the first letter of collimation. As the unit of this index, D and mD, which is one thousandth (1/1000) of D, are used. The index C indicating the degree of collimation of light, which will be simply called the index C, can be used for the above-described target value (typical value).

When a parallel beam of light, a convergent beam of light, and a divergent beam of light are each represented by the index C, the value of the index C of a parallel beam of light is 0, while that of a non-parallel beam of light is other than 0. The value of the index C of a convergent beam of light is a positive value, while that of a divergent beam of light is a negative value.

A plane perpendicular to the optical axis Ax is set as a reference plane. If a beam of light comes into focus one meter (1 m) ahead of this reference plane after passing through the reference plane, it is a convergent beam of light. If the degree of collimation of this convergent beam of light is expressed by the index C, it is the reciprocal of 1, that is, 1 D (1 diopter). If a beam of light comes into focus −1 m ahead of the reference plane, that is, 1 m behind the reference plane, after passing through the reference plane, it is a divergent beam of light. If the degree of collimation of this divergent beam of light is expressed by the index C, it is the reciprocal of −1, that is, −1 D (−1 diopter).

Likewise, the value of the index C of a convergent beam of light having a focal point at 10 m ahead of the reference plane is the reciprocal of 10, that is, 0.1 D=100 mD. The value of the index C of a divergent beam of light having a focal point at −10 m ahead of the reference plane (that is, 10 m behind the reference plane) is the reciprocal of −10, that is, −0.1 D=−100 mD. In the graph 102 of FIG. 1 and the table of FIG. 4, a plane perpendicular to the optical axis Ax passing through the principal point of the condenser 23 is used as the reference plane for the index C.

The Wx profile in the graph 102 of FIG. 1 shows that, when the first output light Lo1 is a parallel beam of light, the minimum value of the size of the image is located at the flat portion of the Wx profile. This means that the beam waist position of the second output light Lo2 is near the position of the focal point F. When the first output light Lo1 is a convergent beam of light, the minimum value of the size of the image is displaced from the position of the focal point F in a direction toward the condenser 23. When the first output light Lo1 is a divergent beam of light, the minimum value of the size of the image is displaced from the position of the focal point F in a direction away from the condenser 23. That is, in the case of a convergent beam of light and a divergent beam of light, the beam waist position is displaced from the position of the focal point F. In other words, if the beam waist position is located near the position of the focal point F, the first output light Lo1 can be assumed to be a parallel beam of light.

The Wx profile also shows that the diameter in the X-axis direction becomes larger as it is farther separated from the position on the Ax axis at which the diameter in the X-axis direction takes the minimum value, that is, the beam waist position. The Wx profile has a substantially symmetrical configuration with respect to the beam waist position. If the beam waist position of the Wx profile in response to certain first output light Lo1 is located near the position of the focal point F of the condenser 23, the degree of matching between the size of the first image and that of the second image measured at positions separated from the focal point F by an equal distance is contained within a predetermined range. Then, the controller 26 or an operator user can judge that the first output light Lo1 is a parallel beam of light. In one example, one of the positions separated from the focal point F by an equal distance is the position separated from the focal point F by the predetermined distance Oft, and the other position is the position separated from the focal point F by the predetermined distance Δf2 (Δf1 Δf2).

The Wx profile also presents the following features regarding the size of the image at the positions separated from the focal point F by an equal distance. When the beam waist position is displaced from the focal point F in a direction toward the condenser 23 (that is, when the first output light Lo1 is a convergent beam of light), the size of the image measured at the position separated from the focal point F toward the condenser 23 remains small, while that at the other position becomes larger. When the beam waist position is displaced from the focal point F in a direction away from the condenser 23 (that is, when the first output light Lo1 is a divergent beam of light), the size of the image measured at the position separated from the focal point F toward the condenser 23 becomes larger, while that at the other position remains small.

The difference between the diameter Wx measured at the position separated from the focal point F by the predetermined distance Δf1 and the diameter Wx at the position separated from the focal point F by the predetermined distance Δf2 is indicated by ΔWx. The difference ΔWx when the first output light Lo1 is a parallel beam of light is compared with that when the first output light Lo1 is a convergent beam of light. The difference AWx when the first output light Lo1 is a convergent beam of light is greater than that when the first output light Lo1 is a parallel beam of light. This is also apparent from FIG. 4. Likewise, the difference ΔWx when the first output light Lo1 is a parallel beam of light is compared with that when the first output light Lo1 is a divergent beam of light. The difference ΔWx when the first output light Lo1 is a divergent beam of light is found to be greater than that when the first output light Lo1 is a parallel beam of light. This is also apparent from FIG. 4.

That is, the size of the first image measured at the position separated from the focal point F by the predetermined distance Δf1 becomes significantly different depending on the mode of the first output light Lo1, that is, whether the first output light Lo1 is a parallel beam of light, a convergent beam of light, or a divergent beam of light. Likewise, the size of the second image measured at the position separated from the focal point F by the predetermined distance Δf2 becomes significantly different depending on the mode of the first output light Lo1, that is, whether the first output light Lo1 is a parallel beam of light, a convergent beam of light, or a divergent beam of light. Hence, as a result of comparing the first image and the second image with each other and judging whether they match each other, it is possible to instantly determine whether the first output light Lo1 is a parallel beam of light, a convergent beam of light, or a divergent beam of light. If the first output light Lo1 is found to be a convergent or divergent beam of light, the controller 26 or an operator user can easily adjust the first output light Lo1 to a parallel beam of light.

This will be explained by the following specific example. An operator user adjusts the position of the light source 11 or the collimator lens 12 in the Z-axis direction while comparing the first image and the second image with each other. During this adjusting operation, the operator user can intuitively determine whether the first image and the second image match each other by visually checking these images. High-precision and speedy adjustment can thus be achieved. At the final stage of the adjusting operation, the operator user adjusts the degree of collimation of the first output light Lo1 so that the above-described difference ΔWx can be contained in the predetermined range. This enables the operator user to perform the adjusting operation, not only intuitively, but also based on the numerical values. The operator user can thus adjust the first output light Lo1 to a parallel beam of light with high precision while reducing errors. In this manner, by comparing the first and second images, the operator user can adjust the degree of collimation of the first output light Lo1 with high precision and with high efficiency. When the controller 26 performs the above-described adjustment based on comparison between the first and second images, it can also speedily and highly precisely adjust the degree of collimation of the first output light Lo1.

As stated above, in the first embodiment, the near position P1 is set to be the position separated from the focal point F by the predetermined distance Δf1, while the far position P2 is set to be the position separated from the focal point F by the predetermined distance Δf2 (Δf≅Δf2). The near position P1 and the far position P2 are set to be positions at which an amount of change of the size of the image of the second output light Lo2 in the profile becomes considerably different depending on the mode of the first output light Lo1. That is, the near position P1 and the far position P2 are set to be positions at which the difference in the amount of change of the size of the image of the second output light Lo2 according to the mode of the first output light Lo1 is greater than or equal to a predetermined amount. More specifically, the near position P1 and the far position P2 are set to be positions at which a relatively large difference between the size of the image of a parallel beam of light and that of a convergent beam of light or a divergent beam of light is observed. The above-described predetermined amount is a value by which the degree of matching between the first image and the second image can be checked with high precision and is set by experiment, for example. The near position P1 and the far position P2 may be set to be positions close to the positions at which the above-described difference in the amount of change of the size of the image of the second output light Lo2 is greater than or equal to the predetermined amount. It can be said that a position at which the above-described difference in the amount of change of the size of the image is greater than or equal to the predetermined amount is a position at which the slope of the tangent line of the profile of the second output light Lo2 (one of a parallel beam of light, a convergent beam of light, and a divergent beam of light) is greater than or equal to a predetermined value.

When a position at which the above-described difference in the amount of change of the size of the image is greater than or equal to the predetermined amount is determined, the controller 26 sets this position to be the near position P1 or the far position P2. If the controller 26 has set the near position P1, it determines the position which is located symmetrically to the near position P1 with respect to the focal point F to be the far position P2. If the controller 26 has set the far position P2, it determines the position which is located symmetrically to the far position P2 with respect to the focal point F to be the near position P1. That is, the controller 26 sets the position separated from the focal point F by the predetermined distance Δf1 to be the near position P1 and the position separated from the focal point F by the predetermined distance Δf2 to be the far position P2. As discussed above, instead of the controller 26, an operator user may set the near position P1 and the far position P2 in the above-described manner.

### (Processing Executed by Output Light Adjusting Device)

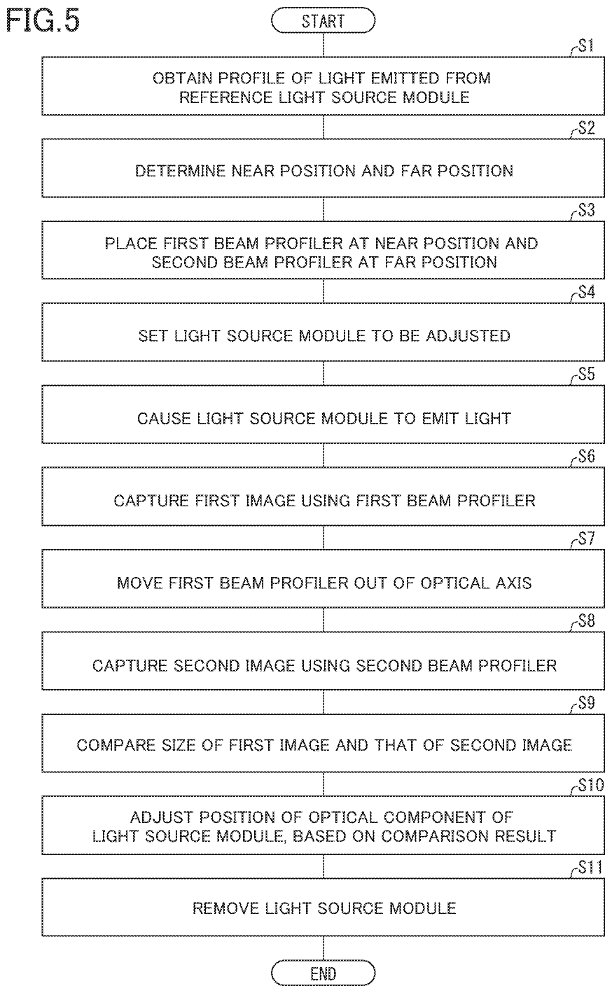

An example of processing (output light adjusting method) executed by the output light adjusting device 20 will be described below with reference to the flowchart of FIG. 5.

In step S1, the controller 26 of the output light adjusting device 20 illustrated in FIG. 2 obtains a profile of the first output light Lo1 (that is, the second output light Lo2) emitted from a light source module 10 which serves as a reference light source module. Among profiles of the second output light Lo2 corresponding to the first output light Lo1 (a parallel beam of light, a convergent beam of light, and a divergent beam of light), such as profiles illustrated in the graph 102 of FIG. 1, the controller 26 obtains profiles to be used for adjusting the degree of collimation of the first output light Lo1. The profiles of the second output light Lo2 may be obtained by another approach, such as computer simulation. Then, in step S2, the controller 26 specifies positions at which the difference in the amount of change of the size of the image of the second output light Lo2 according to the mode of the first output light Lo1 is greater than or equal to a predetermined amount, and then determines these specified positions to be the near position P1 and the far position P2.

In step S3, the controller 26 drives the movement mechanism to place the first beam profiler 24 at the near position P1 and the second beam profiler 25 at the far position P2. Then, in step S4, a light source module 10, which is a subject to be adjusted, is attached to the output light adjusting device 20. Then, in step S5, the controller 26 supplies a current to the light source 11 of the light source module 10 so that the light source 11 emits light.

In step S6, the first beam profiler 24 captures (measures) the first image of the second output light Lo2, which is incident via the condenser 23. The first beam profiler 24 sends measurement data indicating the size of the first image to the comparator 261. After the first image is captured, in step S7, the movement mechanism moves the first beam profiler 24 out of the optical axis Ax so as to let the second beam profiler 25 capture the second image of the second output light Lo2. In step S8, the second beam profiler 25 captures the second image of the second output light Lo2. The second beam profiler 25 sends measurement data indicating the size of the second image to the comparator 261.

In step S9, the comparator 261 compares the size of the first image and that of the second image with each other, and sends a comparison result to the output light adjuster 262. In step S10, the output light adjuster 262 adjusts the position of an optical component of the light source module 10, based on the comparison result. More specifically, the output light adjuster 262 determines the amount by which the Z-axis position of the light source 11 or the collimator lens 12 is to be adjusted so that the degree of matching between the size of the first image and that of the second image is contained within the above-described predetermined range. Based on the amount of adjustment determined by the output light adjuster 262, the position adjusting mechanism 27 adjusts the position of the light source 11 or the collimator lens 12 in the Z-axis direction under the control of the output light adjuster 262. When the output light adjuster 262 has judged that the size of the first image and that of the second image match each other within the predetermined range, it finishes the adjustment. Finally, in step S11, an operator user removes the light source module 10 from the output light adjusting device 20, and the processing has been completed. If another light source module 10 is to be adjusted under the same conditions, the process may return from step S11 to step S4, and steps S4 through S11 may be repeated.

All or some of the steps of the above-described processing executed by the controller 26 of the output light adjusting device 20 shown in FIG. 2 may be performed by an operator user. In this case, an operator user may perform adjusting operation in the following manner. Instead of the movement mechanism, the operator user may place the first and second beam profilers 24 and 25 in step S3 or move the first beam profiler 24 out of the optical axis Ax in step S7. In step S10, the operator user may adjust the position of the light source 11 or the collimator lens 12 in the Z-axis direction by checking on the display device 40 (see FIG. 3) the adjustment amount specified by the adjustment amount specifier 265 shown in FIG. 3 based on a comparison result of the comparator 261. In steps S9 and S10, the operator user may adjust the position of the light source 11 or the collimator lens 12 in the Z-axis direction by checking images including the first and second images displayed on the display device 40 (see FIG. 3). Steps S1 through S3 may also be executed by the operator user. The operator user may specify the near position P1 and the far position P2 by checking the profile of the second output light Lo2 corresponding to the first output light Lo1, which is measured by the reference light source module 10 or obtained by computer simulation. Then, the operator user may place the first beam profiler 24 at the specified near position P1 and the second beam profiler 25 at the specified far position P2.

### (Advantages)

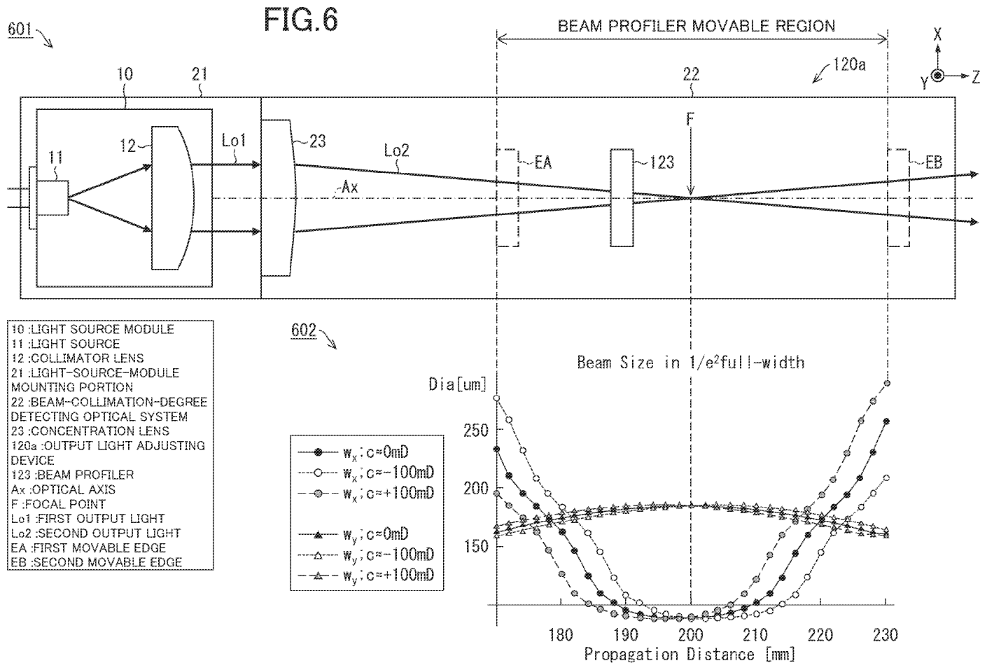

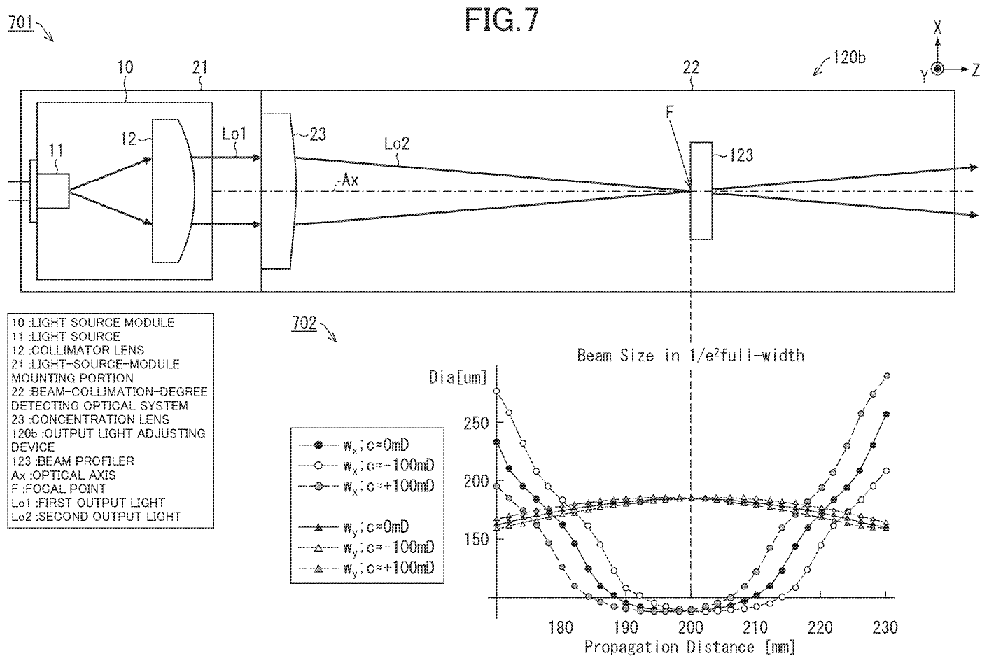

It may be possible that the degree of collimation of the first output light Lo1 emitted from a light source module 10, which is a subject to be adjusted, be adjusted by using an output light adjusting device 120a shown in FIG. 6 or an output light adjusting device 120b shown in FIG. 7.

A schematic view 601 of FIG. 6 illustrates an example of the output light adjusting device 120a, which is a comparative example of the output light adjusting device 20. A graph 602 of FIG. 6 illustrates examples of profiles of images of second output light Lo2. Each profile indicates the size of an image of the second output light Lo2 on a plane perpendicular to the optical axis Ax in accordance with the position of the second output light Lo2 on the optical axis Ax.

As shown in the schematic view 601 of FIG. 6, the output light adjusting device 120a shifts a single beam profiler 123 from a first movable edge EA to a second movable edge EB (or from the second movable edge EB to the first movable edge EA) along the optical axis Ax (Z-axis direction). The output light adjusting device 120a obtains a corresponding profile of the image of the second output light Lo2 illustrated in the graph 602 of FIG. 6 while shifting the beam profiler 123. The output light adjusting device 120a or an operator user calculates the beam waist position based on this profile, thereby finding and adjusting the degree of collimation of the first output light Lo1 emitted from a light source module 10 to be adjusted.

In this method, however, it takes time to move the beam profiler 123 in the Z-axis direction, capture multiple items of image data, create a graph illustrating the beam spot size in the Z-axis direction (the above-described Wx and Wy profiles), and calculate the beam waist position. Among others, if the degree of collimation of the first output light Lo1 emitted from a light source module 10 is adjusted by using this method, an operator user is required to judge whether the calculated beam waist position matches a focal point formed by an ideally adjusted first output light Lo1 while finely adjusting the light source 11 or the collimator lens 12 in the Z-axis direction. Because of such time-consuming measurements and calculations, using the output light adjusting device 120a is not practical in terms of mass production of light source modules 10.

A schematic view 701 of FIG. 7 illustrates an example of the output light adjusting device 120b, which is another comparative example of the output light adjusting device 20. A graph 702 of FIG. 7 illustrates examples of profiles of images of second output light Lo2. Each profile indicates the size of an image of the second output light Lo2 on a plane perpendicular to the optical axis Ax in accordance with the position of the second output light Lo2 on the optical axis Ax.

As shown in the schematic view 701 of FIG. 7, in the output light adjusting device 120b, a single beam profiler 123 is fixed at one position on the optical axis Ax (Z axis). In the output light adjusting device 120b, the beam waist position when first output light Lo1 emitted from a light source module 10, which is adjusted to the ideal state, is input into the output light adjusting device 120b is estimated. The beam profiler 123 is fixed at this beam waist position. Then, the degree of collimation of the first output light Lo1 emitted from a light source module 10, which is a subject, is adjusted.

In this case, by matching the beam waist position inside the output light adjusting device 120b to the fixed position of the beam profiler 123 while moving the light source 11 or the collimator lens 12 in the Z-axis direction, the degree of collimation of the first output light Lo1 can be adjusted. As illustrated in the graph 702 of FIG. 7, however, in the profile of the second output light Lo2, the sizes of the images of the second output light Lo2 at and near the beam waist position are substantially the same. It is thus difficult to specify the actual beam waist position by using the fixed beam profiler 123. This may decrease the accuracy of the adjustment result, as well as it takes time to perform adjusting operation for the degree of collimation of the first output light Lo1.

In contrast, in the output light adjusting device 20 of the first embodiment, as a result of comparing the size (shape) of the first image obtained at the near position P1 and that of the second image obtained at the far position P2, the degree of collimation of the first output light Lo1 can be adjusted so that the first output light Lo1 becomes a parallel beam of light. In this manner, with a simple method, the output light adjusting device 20 or an operator user is able to speedily and highly precisely adjust the degree of collimation of the first output light Lo1 emitted from a light source module 10 to a desired degree of collimation.

### Second Embodiment

A second embodiment of the disclosure will be described below. For the sake of description, an element having the same function as that in the first embodiment is designated by like reference numeral, and an explanation thereof will not be repeated. The other embodiments will be explained in a similar manner.

In the first embodiment, as discussed above, although the first beam profiler 24 is disposed at the near position P1, it is moved out of the optical axis Ax when the second beam profiler 25 captures the second image. In the second embodiment, the initial arrangement of the first and second beam profilers 24 and 25 is maintained.

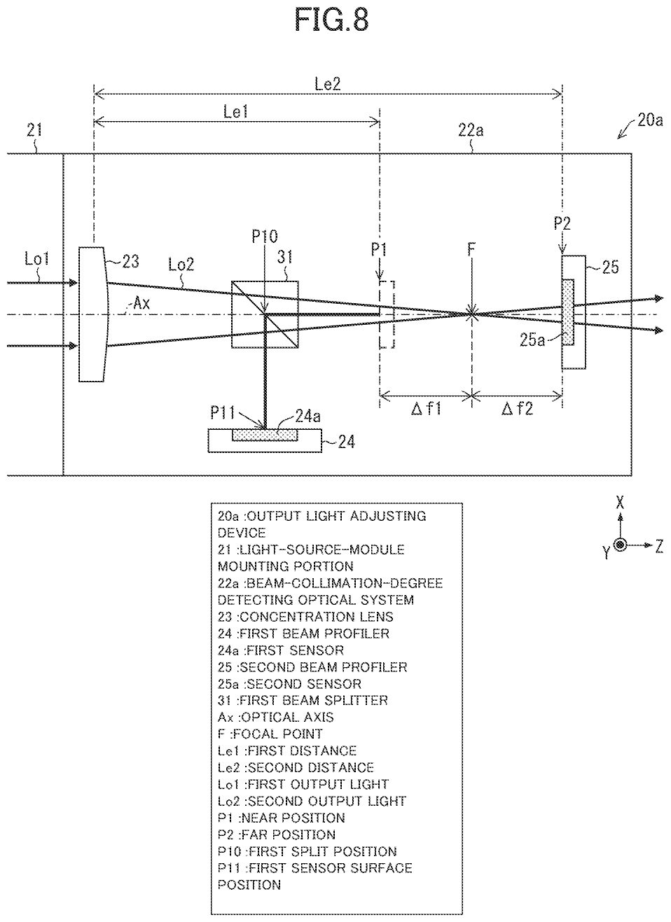

FIG. 8 illustrates an example of an output light adjusting device 20a according to the second embodiment. As shown in FIG. 8, the output light adjusting device 20a includes a light-source-module mounting portion 21 and a beam-collimation-degree detecting optical system 22a. The function of the beam-collimation-degree detecting optical system 22a is similar to that of the beam-collimation-degree detecting optical system 22. However, the position of the first beam profiler 24 is different from that in the beam-collimation-degree detecting optical system 22 in the first embodiment. Due to a change of the position of the first beam profiler 24, the beam-collimation-degree detecting optical system 22a includes a first beam splitter 31 (first light splitter).

The first beam splitter 31 splits the path of the second output light Lo2. More specifically, the first beam splitter 31 causes part of the second output light Lo2 to split off from the optical axis Ax. In the second embodiment, the first beam splitter 31 causes part of the second output light Lo2 to split off in a direction perpendicular to the optical axis Ax (−X-axis direction in FIG. 8). The first beam profiler 24 is disposed at a position at which it can receive the entirety or part of the second output light Lo2 which is shifted to the outside of the optical axis Ax by the first beam splitter 31. The second beam profiler 25 is disposed at the far position P2, as in the first embodiment.

The first beam profiler 24 is disposed at a position at which the distance between the near position P1 and a first split position P10 becomes equal to that between the first split position P10 and the first beam profiler 24. The first split position P10 is a position at which the first beam splitter 31 splits the second output light Lo2. Specifically, the distance between the first split position P10 and the first beam profiler 24 is the distance between the first split position P10 and a first sensor surface position P11. The first sensor surface position P11 is the position of a surface on which a first sensor 24a (imaging element) of the first beam profiler 24 captures the first image.

When the first beam profiler 24 is arranged in this manner, the length of the path of the second output light Lo2 from the condenser 23 to the first sensor surface position P11 via the first split position P10 becomes substantially equal to the first distance Le1. The size of the first image captured by the first beam profiler 24 becomes substantially equal to that of the first image captured at the near position P1. That is, as in the first embodiment, by comparing the size of the first image and that of the second image with each other, the output light adjusting device 20a can adjust the degree of collimation so that the first output light Lo1 becomes a parallel beam of light.

Using the output light adjusting device 20a eliminates the need to move the first beam profiler 24, unlike the first embodiment. This can save an operator user installing and removing a movement mechanism in and from the output light adjusting device 20a. This also saves the operator user moving the first beam profiler 24.

The operator user adjusts the degree of collimation of the first output light Lo1 while moving the light source 11 or the collimator lens 12 by comparing the first image and the second image with each other. Without the need to move the first beam profiler 24, the operator user can continue performing adjusting operation for the degree of collimation of the first output light Lo1 without stopping to move the first beam profiler 24. That is, without discontinuing performing adjusting operation, the operator user can intuitively determine whether the first image and the second image match each other by visually checking these images. More speedy, high-precision adjustment can thus be performed. At the final stage of the adjusting operation, the operator user adjusts the degree of collimation of the first output light Lo1 so that the above-described difference ΔWx can be contained in the predetermined range. This enables the operator user to perform adjusting operation, not only intuitively, but also based on the numerical values. The operator user can thus adjust the first output light Lo1 to a parallel beam of light with high precision while reducing errors. In this manner, by comparing the first and second images without moving the first beam profiler 24, the operator user can highly precisely adjust the degree of collimation of the first output light Lo1 with even higher efficiency than in the first embodiment. When the controller 26 performs the above-described adjustment based on comparison between the first and second images, it can also more speedily and highly precisely adjust the degree of collimation of the first output light Lo1.

Although a detailed explanation is omitted in the specification, if an optical component is disposed on the path of the second output light Lo2 and transmits the second output light Lo2, the second output light Lo2 is influenced by the refractive index of this optical component. In this case, the position of the focal point F of the condenser 23 is shifted to a focal point F′. In the second embodiment, the first beam splitter 31 is an example of this optical component.

The near position P1 is set at a position separated from the focal point F by the predetermined distance Δf1, while the far position P2 is set at a position separated from the focal point F by the predetermined distance Δf2. Reflecting the influence of the refractive index of the first beam splitter 31, the near position P1 is shifted the near position P1′ separated from the focal point F′ by the predetermined distance Δf1, while the far position P2 is shifted to the far position P2′ separated from the focal point F′ by the predetermined distance Δf2. To put it more precisely, the first distance Le1 is changed to the first distance Le1′ between the condenser 23 and the near position P1′, while the second distance Le2 is changed to the second distance Le2′ between the condenser 23 and the far position P2′.

With the influence of the refractive index of the first beam splitter 31, the second embodiment is to be explained by using the adjusted focal point F′, near position P1′, far position P2′, first distance Le1′, and second distance Le2′. For the sake of easy description, however, in the second embodiment, the focal point F, near position P1, far position P2, first distance Le1, and second distance Le2 are used.

Adjustment to be made by disposing an optical component on the path of the second output light Lo2 in the second and subsequent embodiments is merely a design matter apparent in the optical designing field. Likewise, in the first embodiment, if an optical component, such as a translucent first beam profiler 24, is disposed on the path of the second output light Lo2 when the second beam profiler 25 captures the second image, adjustment is also to be made, which is also a merely design matter.

(Comparison with Comparative Example)

In the output light adjusting device 120a shown in FIG. 6, which is a comparative example of the first embodiment, the beam profiler 123 is moved in the beam profiler movable region between the first movable edge EA and the second movable edge EB. A mechanical mover to move the beam profiler 123 is thus included in the output light adjusting device 120a. In this manner, the output light adjusting device 120a adjusts the degree of collimation of the first output light Lot while moving the beam profiler 123. Hence, recalibration may be required, or a failure due to mechanical wear, for example, may occur.

In the output light adjusting device 20a of the second embodiment, the position of the first beam profiler 24 is fixed. This can reduce the above-described inconveniences, such as the execution of recalibration or the occurrence of a failure.

By using the output light adjusting device 20a of the second embodiment and the output light adjusting device 120b of the comparative example shown in FIG. 7, the same operator user adjusted the degree of collimation of the first output light Lo1 multiple times. The time for the adjusting operation in the output light adjusting device 20a and that in the output light adjusting device 120b were the same. By using the output light adjusting device 20a, the operator user was able to adjust the degree of collimation of light within a range of about ±30 mD. By using the output light adjusting device 120b of the comparative example, variations of about ±300 mD were observed although the operator user performed the adjusting operation with extra care.

### Third Embodiment

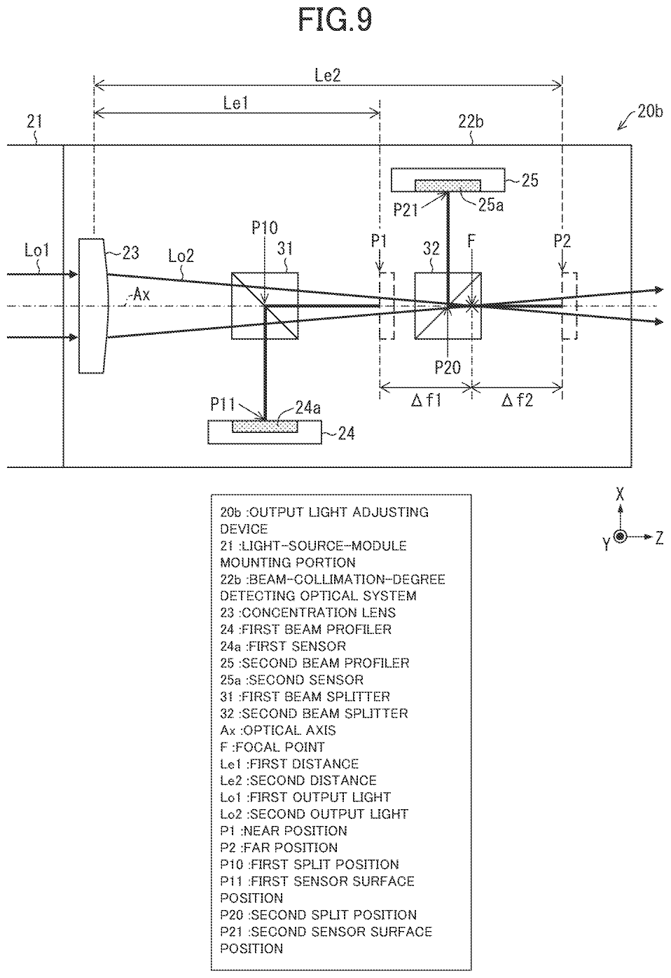

FIG. 9 illustrates an example of an output light adjusting device 20b according to a third embodiment. As shown in FIG. 9, the output light adjusting device 20b includes a light-source-module mounting portion 21 and a beam-collimation-degree detecting optical system 22b. As shown in FIG. 9, the beam-collimation-degree detecting optical system 22b is different from the beam-collimation-degree detecting optical system 22a in the second embodiment in that the second beam profiler 25, as well as the first beam profiler 24, is disposed outside the optical axis Ax. Due to a change of the position of the second beam profiler 25, the beam-collimation-degree detecting optical system 22b includes a second beam splitter 32 (second light splitter).

The second beam splitter 32 splits the path of the second output light Lo2. More specifically, the second beam splitter 32 causes part of the second output light Lo2 to split off from the optical axis Ax. In the third embodiment, the second beam splitter 32 causes part of the second output light Lo2 to split off in a direction perpendicular to the optical axis Ax (+X-axis direction in FIG. 9). The second beam profiler 25 is disposed at a position at which it can receive the entirety or part of the second output light Lo2 which is shifted to the outside of the optical axis Ax by the second beam splitter 32.

The second beam profiler 25 is disposed at a position at which the distance between the far position P2 and a second split position P20 becomes equal to that between the second split position P20 and the second beam profiler 25. The second split position P20 is a position at which the second beam splitter 32 splits the second output light Lo2. Specifically, the distance between the second split position P20 and the second beam profiler 25 is the distance between the second split position P20 and a second sensor surface position P21. The second sensor surface position P21 is the position of a surface on which a second sensor 25a (imaging element) of the second beam profiler 25 captures the second image.

When the second beam profiler 25 is arranged in this manner, the length of the path of the second output light Lo2 from the condenser 23 to the second sensor surface position P21 via the second split position P20 becomes substantially equal to the second distance Le2. The size of the second image captured by the second beam profiler 25 becomes substantially equal to that of the second image captured at the far position P2. That is, as in the first and second embodiments, by comparing the size of the first image and that of the second image with each other, the output light adjusting device 20b can adjust the degree of collimation so that the first output light Lot becomes a parallel beam of light.

In the output light adjusting device 20b, the second beam profiler 25 does not interfere with the traveling of the second output light Lo2. After passing through the second beam splitter 32, the second output light Lo2 can be incident on an optical instrument disposed at the stage subsequent to the output light adjusting device 20b. For example, if a lens or an autocollimator is disposed as an optical instrument at the subsequent stage, the optical axis of the light source module 10 can be adjusted. Depending on the type of optical instrument at the subsequent stage, the properties of the second output light Lo2 (first output light Lo1 emitted from the light source module 10) may be evaluated.

In the output light adjusting device 20b, the first beam profiler 24 may be movable to the near position P1, that is, the first beam profiler 24 may be detachable, as in the first embodiment.

As discussed in the second embodiment, due to the influence of the refractive index of the optical component (first and second beam splitters 31 and 32 in the third embodiment), the position of the focal point F of the condenser 23 is shifted to a focal point F″. Reflecting the influence of the refractive index of the first and second beam splitters 31 and 32, the near position P1 is shifted to the near position P1″ separated from the focal point F″ by the predetermined distance Δf1, while the far position P2 is shifted to the far position P2″ separated from the focal point F″ by the predetermined distance Δf2. In the output light adjusting device 20b shown in FIG. 9, since the second beam splitter 32, which is an optical component, is disposed on the path indicated by Δf1 and Δf2, Δf1″ and Δf2″ may be used instead of Δf1 and Δf2 by reflecting the influence of the refractive index of the second beam splitter 32. To put it more precisely, the first distance Le1 is changed to the first distance Le1″ between the condenser 23 and the near position P1″, while the second distance Le2 is changed to the second distance Le2″ between the condenser 23 and the far position P2″. For the sake of easy description, however, in the third embodiment, the focal point F, near position P1, far position P2, first distance Le1, and second distance Le2 are used, as in the second embodiment.

### Fourth Embodiment

In the first through third embodiments, adjustment is made so that the first output light Lo1 emitted from the light source module 10 becomes a substantially parallel beam of light. As discussed in the first embodiment, however, a target value (desired degree of collimation) may be set to make the first output light Lo1 become a preset convergent beam of light or a preset divergent beam of light instead of a parallel beam of light.

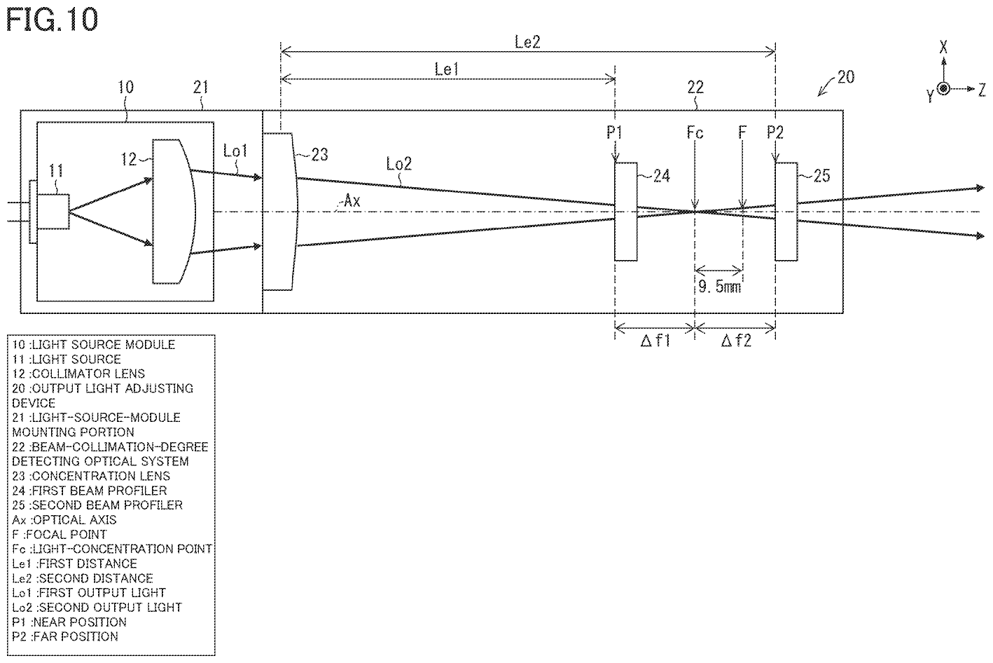

FIG. 10 illustrates an arrangement example of the first beam profiler 24 and the second beam profiler 25 of the output light adjusting device 20 when the degree of collimation of the first output light Lo1 is adjusted to make the first output light Lo1 become a preset convergent beam of light. As shown in FIG. 10, in a fourth embodiment, as a preset reference light-concentration position of the second output light Lo2, a light-concentration point Fc is set. The light-concentration point Fc is located at a position at which the second output light Lo2 comes into focus and is closer to the condenser 23 than the focal point F is. That is, the light-concentration point Fc is located at a position at which the second output light Lo2 comes into focus when the first output light Lo1 becomes a preset convergent beam of light.

It is now assumed that, as the target value (desired degree of collimation) of the first output light Lo1 (convergent beam of light), the value of the index C is set to be +250 mD. In this case, the first output light Lo1 having the desired degree of collimation is a convergent beam of light which comes into focus at a 4 m ahead of the reference plane. When the first output light Lo1 adjusted as described above is input into the output light adjusting device 20, the light-concentration point Fc is positioned closer to the condenser 23 than the focal point F is.

With the lens equation, the light-concentration point is calculated as follows. When a parallel beam of light of ±0 mD is incident on a condenser 23 having a focal length of 200 mm, it passes through the condenser 23 and is concentrated at the focal point F which is 200 mm ahead of the principal point of the condenser 23. In contrast, when a convergent beam of light of +250 mD is incident on the condenser 23, it is concentrated at the light-concentration point Fc which is 190.5 mm ahead of the principal point of the condenser 23. That is, the light-concentration point Fc is closer to the condenser 23 than the focal point F is by 9.5 mm.

The near position P1 and the far position P2 are set to be positions at which the amount of change in the size of the image of the second output light Lo2, which corresponds to the first output light Lo1 having +250 mD, depending on the position on the optical axis Ax (Z-axis direction) in the obtained profile is greater than or equal to a predetermined amount. The position on the optical axis Ax is the position on the Z axis. The profile of the second output light Lo2 can be generated as follows. A light source module 10 which emits first output light Lo1 of +250 mD is mounted on the light-source-module mounting portion 21, and the first output light Lo1 emitted from the light source module 10 is received by the condenser 23. A position at which the amount of change in the size of the image of the second output light Lo2 becomes greater than or equal to the predetermined amount may be specified by using a graph illustrating a plot of the beam spot size along the Z-axis direction (Wx profile, for example), such as the graph 102 of FIG. 1.

The near position P1 and the far position P2 may be specified by another approach, such as computer simulation, instead of using the light source module 10 which emits a convergent beam of light of +250 mD.

In the fourth embodiment, a position closer to the condenser 23 than the light-concentration point Fc is is set to be the near position P1, while a position farther away from the condenser 23 than the light-concentration point Fc is is set to be the far position P2. In the fourth embodiment, the distance from the light-concentration point Fc to the near position P1 is represented by Δf1, while the distance from the light-concentration point Fc to the far position P2 is represented by Δf2. The distance from the condenser 23 to the specified near position P1 is set to be a first distance Le1, while the distance from the condenser 23 to the specified far position P2 is set to be a second distance Le2.

The degree of collimation of the first output light Lo1 emitted from a light source module 10, which is a subject, is adjusted by using the method discussed in the first embodiment. Adjustment may be made with a predetermined (desired) level of precision. For example, the degree of collimation of the first output light Lo1 may be adjusted within an allowance of ±50 mD with respect to the center value of +250 mD. In this case, the tolerable range of the target value results in +200 mD to +300 mD.

When the degree of collimation of the first output light Lo1 is adjusted so that the first output light Lo1 becomes a preset divergent beam of light, as the above-described reference light-concentration position, a light-concentration point Fd at which the second output light Lo2 comes into focus is set. The light-concentration point Fd is farther separated from the condenser 23 than the focal point F is. That is, the light-concentration point Fd is a position at which the second output light Lo2 comes into focus when the first output light Lo1 becomes a preset divergent beam of light.

It is now assumed that, as the target value (desired degree of collimation) of the first output light Lo1 (divergent beam of light), the value of the index C is set to be −250 mD. In this case, the light-concentration point Fd is located at a position separated from the principal point of the condenser 23 by 210.5 mm. That is, the light-concentration point Fd is located at a position separated from the focal point F by 10.5 mm in the +Z-axis direction. The near position P1 and the far position P2 are specified similarly to when the first output light Lo1 is adjusted to a preset convergent beam of light. Likewise, the distance from the light-concentration point Fd to the near position P1 is represented by Δf1, while the distance from the light-concentration point Fd to the far position P2 is represented by Δf2. The distance from the condenser 23 to the near position P1 is set to be a first distance Le1, while the distance from the condenser 23 to the far position P2 is set to be a second distance Le2. The degree of collimation of the first output light Lo1 emitted from a light source module 10 may be adjusted with a predetermined (desired) level of precision. For example, the degree of collimation of the first output light Lo1 may be adjusted with an allowance of ±100 mD with respect to the center value of −250 mD. In this case, the tolerable range of the target value is −350 mD to −150 mD.

### (Supplement)

In an ideal optical system with almost no aberration, Δf1 and Δf2 are substantially equal to each other (Δf1≅Δf2). That is, in such an ideal optical system, the distance between the light-concentration point Fc or Fd and the near position P1 is substantially equal to that between the light-concentration point Fc or Fd and the far position P2. Due to various influences, such as aberration of an optical system, however, Δf1 and Δf2 may not become equal to each other (Δf1≠Δf2). Even in this case, if the size of the image of the second output light Lo2 in the Z-axis direction is changed by a sufficient amount and if the degree of collimation of the first output light Lo1 is adjusted with high precision, positions at which Δf1≠Δf2 may be set as the near position P1 and the far position P2.

In the output light adjusting device 20a of the second embodiment and the output light adjusting device 20b of the third embodiment, the first output light Lo1 can be adjusted to a preset convergent beam of light or a preset divergent beam of light, as discussed above.

### Fifth Embodiment

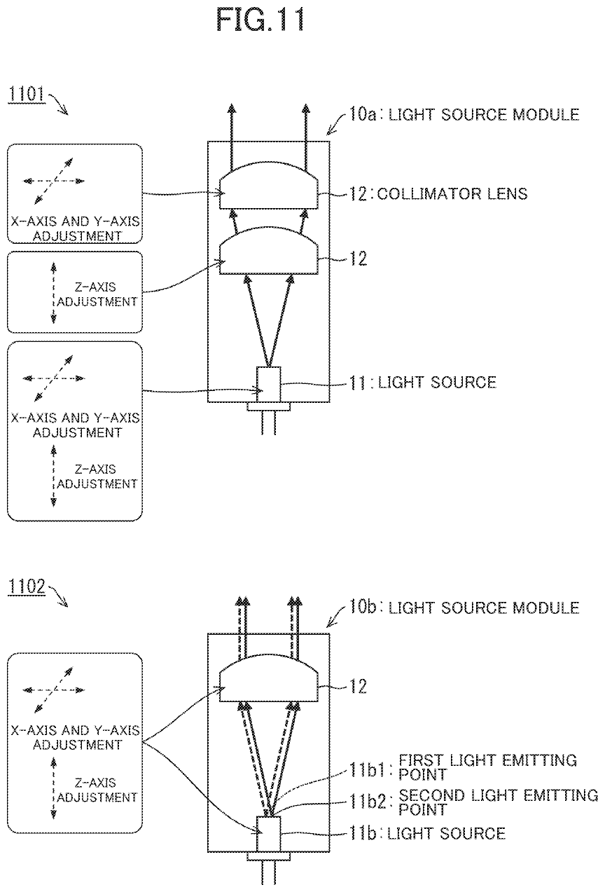

In the first through fourth embodiments, a light source module 10 including one light source 11 and one collimator lens 12 is used. However, a light source module to be adjusted is not limited to this type. FIGS. 11 through 13 illustrate modified examples of the light source module 10.

(1) A light source module 10a may include one light source 11 and plural collimator lens 12 as optical components. The light source module 10a shown in a schematic diagram 1101 of FIG. 11 includes one light source 11 and two collimator lenses 12. In this case, the degree of collimation of first output light Lo1 can be adjusted by utilizing the function of only one of the collimator lenses 12.

The collimator lens 12 disposed near the light source 11 and that separated from the light source 11 may have different functions regarding the position adjustment of the collimator lenses 12. In the example of the schematic diagram 1101 of FIG. 11, the collimator lens 12 near the light source 11 is movable only in the Z-axis direction. The degree of collimation of first output light Lo1 is thus adjusted by controlling the position of this collimator lens 12. The other collimator lens 12 is movable only in the X-Y plane. The emitting direction of the first output light Lo1 is thus adjusted by controlling the position of this collimator lens 12. In this light source module 10a, the emission of the first output light Lo1 from the light source 11 can be adjusted with even higher precision.

(2) A light source module 10b includes a light source 11b having plural light emitting points and a collimator lens 12 as optical components. In the light source module 10b shown in a schematic diagram 1102 of FIG. 11, the light source 11b has a first light emitting point 11b1 and a second light emitting point 11b2.

(3) A light source module 10c includes plural light sources 11 and plural collimator lenses 12 as optical components. The light sources 11 and the collimator lenses 12 are disposed based on a one-on-one correspondence. As shown in a schematic diagram 1201 of FIG. 12, the light source module 10c includes three light sources 11 and three light collimator lenses 12. Beams of light emitted from the individual light sources 11 may have different peak wavelengths or the same peak wavelength. If two or more light sources 11 having different emission wavelengths are used, using of an achromatic lens as the condenser 23 is suitable.

The light source module 10c is movable in the X-axis direction so that each pair of a light source 11 and a collimator lens 12 can be placed right under the condenser 23. This allows the output light adjusting device 20 or an operator user to sequentially adjust the degree of collimation of the first output light Lot for each pair of a light source 11 and a collimator lens 12.

(4) A light source module 10d includes plural light sources 11 and plural collimator lenses 12 as optical components and also includes plural dichroic mirrors 13. The light source module 10d is equivalent to the light source module 10c to which the dichroic mirrors 13 are added. The dichromic mirrors 13 and the collimator lenses 12 are disposed based on a one-on-one correspondence. The light source module 10c shown in a schematic diagram 1202 of FIG. 12 includes three light sources 11, three collimator lenses 12, and three dichroic mirrors 13.

In the light source module 10d, beams of light emitted from the individual light sources 11 are reflected by the associated dichroic mirrors 13 in a predetermined direction. This enables the light source module 10d to align the optical axes of the beams of light and to output them together to the condenser 23 as first output light Lo1. As a result of sequentially turning ON a light source 11 to be adjusted, the output light adjusting device 20 or an operator user is able to sequentially adjust the degree of collimation of the first output light Lo1 emitted from the corresponding light source 11 via the associated collimator lens 12.

Although the dichroic mirrors 13 are used in this example, a combiner prism integrating the functions of multiple dichromic mirrors 13 may alternatively be used.

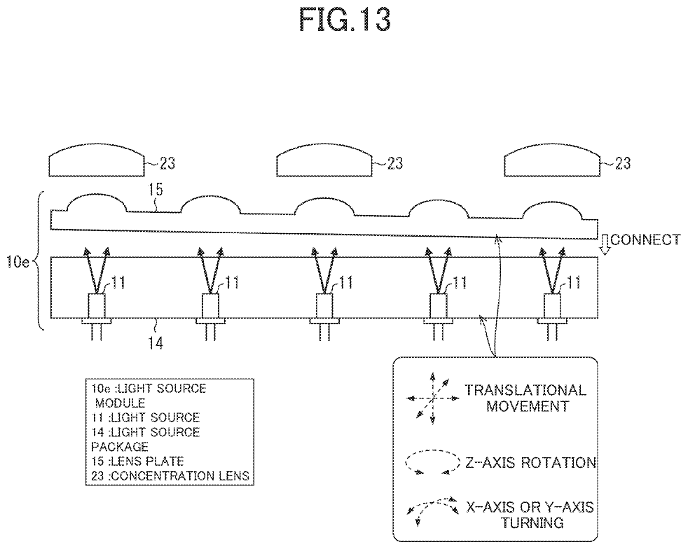

(5) As shown in FIG. 13, a light source module 10e includes a light source package 14 and a lens plate 15 as optical components. The light source package 14 includes linearly or two-dimensionally arranged multiple light sources 11. The lens plate 15 includes linearly or two-dimensionally arranged multiple lenses. Before the lens plate 15 is mounted (fixed) on the light source package 14, the light source module 10e, which is a subject, is attached to the light-source-module mounting portion 21, and then, the degree of collimation of the first output light Lo1 is adjusted. After this adjustment, the lens plate 15 is fixed to the light source package 14 by bonding, welding, or with a mechanical fastening mechanism.

The output light adjusting device 20 may include plural condenseres 23 when adjusting the degree of collimation of light emitted from the light source module 10e. In this case, in the output light adjusting device 20, a first beam profiler 24 and a second beam profiler 25 are disposed on the optical axis Ax (Z axis) of each condenser 23. This enables the output light adjusting device 20 to compare a first image captured by the first beam profiler 24 and a second image captured by the second beam profiler 25 disposed for each condenser 23. The output light adjusting device 20 can thus simultaneously adjust the degrees of collimation of multiple beams of output light Lo1 emitted from the light source module 10e and incident on the condenseres 23.

The degree of collimation of first output light Lo1 can be adjusted by rotating the light source package 14 and/or the lens plate 15 around the Z axis, turning the light source package 14 and/or the lens plate 15 toward the X-axis or the Y-axis direction, or bringing the light source package 14 and/or the lens plate 15 into translational movement in the X-axis, Y-axis, or Z-axis direction. In this case, the degree of collimation may be adjusted only for one of the light source package 14 and the lens plate 15 or for both of them.

### [Implementation Example Using Software]

Control blocks of the output light adjusting devices 20, 20a, and 20b (in particular, the elements of the controller 26) may be implemented by a logical circuit (hardware) formed on an integrated circuit (IC chip) or by software.

If the control blocks are implemented by software, the output light adjusting devices 20, 20a, and 20b each include a computer that executes instructions of a program, which is software implementing the individual functions. The computer includes at least one processor (control device) and at least one computer-readable recording medium storing this program. As a result of the processor reading the program from the recording medium and executing it, an aspect of the disclosure is achieved. As the processor, a central processing unit (CPU), for example, may be used. As the above-described recording medium, a “non-transitory tangible medium”, such as a read only memory (ROM), tape, a disk, a card, a semiconductor memory, or a programmable logic circuit, may be used. The computer may include a random access memory (RAM) into which the above-described program is loaded. The program may be supplied to the computer via a certain transmission medium (such as a communication network or broadcast waves) through which the program is transmittable. An aspect of the disclosure may be realized in the form of a data signal embedded in a carrier wave in which the above-described program is implemented through digital transmission.

### [Conclusions]

An output light adjusting device according to a first aspect of the disclosure is an output light adjusting device for adjusting a degree of collimation of first output light emitted from a light source module or for making the degree of collimation of the first output light adjustable. The light source module is a subject to be adjusted. The output light adjusting device includes first and second image obtainers. The first image obtainer obtains a first image of second output light output from a condenser. The condenser receives the first output light. The first image is obtained at a position at which a length of a path of the second output light output from the condenser matches a first distance. The first distance is a distance from the condenser to a near position. The second image obtainer obtains a second image of the second output light at a position at which the length of the path of the second output light output from the condenser matches a second distance. The second distance is a distance from the condenser to a far position. The near position is a position which is close to the condenser on an optical axis of the condenser and which is separated from a preset reference light-concentration position of the second output light by a predetermined distance. The far position is a position which is located at a side opposite the near position on the optical axis with the reference light-concentration position interposed therebetween and which is separated from the reference light-concentration position by a predetermined distance.

With the above-described configuration, the first image of the second output light is obtained at a position at which the length of the path of the second output light matches the first distance, while the second image is obtained at a position at which the length of the path of the second output light matches the second distance. That is, regardless of whether the first image obtainer is disposed at the near position and whether the second image obtainer is disposed at the far position, it is possible to obtain a first image having substantially the same size as the first image that can be obtained at the near position and a second image having substantially the same size as the second image that can be obtained at the far position. Accordingly, the size of the first image and that of the second image can be compared with each other, and based on a comparison result, the degree of collimation of the first output light can be adjusted.

Therefore, with a simple method, the output light adjusting device or an operator user is able to speedily and highly precisely adjust the degree of collimation of the first output light emitted from a light source module, which is a subject, to a desired degree of collimation. That is, the output light adjusting device or an operator user is able to adjust the first output light to a preset parallel beam of light, a preset convergent beam of light, or a preset divergent beam of light.

In an output light adjusting device according to a second aspect of the disclosure, in the first aspect, the reference light-concentration position may be the position of a focal point of the condenser. With this configuration, the output light adjusting device or an operator user can adjust the first output light to a parallel beam of light.

In an output light adjusting device according to a third aspect of the disclosure, in the first or second aspect, the far position may be a position located symmetrically to the near position with respect to the reference light-concentration position on the optical axis. With this configuration, the near position and the far position can be set easily.

In an output light adjusting device according to a fourth aspect of the disclosure, in one of the first through third aspects, a profile indicating a size of an image of the second output light on a plane perpendicular to the optical axis may be obtained in advance. The size of the image in the profile is indicated in accordance with a position of the second output light on the optical axis. An amount of change of the size of the image in the profile becomes different in accordance with the mode of the first output light. The near position and the far position may be set to be at or close to positions at which a difference in the amount of change of the size of the image according to the mode of the first output light is greater than or equal to a predetermined amount.

With this configuration, at a position at which the difference in the amount of change of the size of the image is greater than or equal to the predetermined amount, the size of the image is relatively different in accordance with whether the first output light is a parallel beam of light or a non-parallel beam of light. Such positions or adjacent positions are set to be the near position and the far position, so that the output light adjusting device or an operator user can compare the shape of the image of the second output light at the near position and that at the far position speedily and highly precisely.

In an output light adjusting device according to a fifth aspect of the disclosure, in one of the first through fourth aspects, the second image obtainer may be disposed at the far position, and the first image obtainer may be disposed at the near position at least when the first image obtainer obtains the first image of the second output light at the near position and may be moved out of the optical axis when the second image obtainer obtains the second image of the second output light at the far position.

With this configuration, as a result of disposing the first and second image obtainers on the optical axis, the first image obtainer can obtain the first image, while the second image obtainer can obtain the second image.

In one of the first through fourth aspects, an output light adjusting device according to a sixth aspect of the disclosure may further include a first light splitter that splits the path of the second output light. The second image obtainer may be disposed at the far position. The first image obtainer may be disposed at a position at which it is able to receive the second output light which is split off to outside the optical axis by the first light splitter. The position of the first image obtainer may be a position at which a distance between the near position and a first split position, the first split position being a position at which the first light splitter splits the second output light, becomes equal to a distance between the first split position and the first image obtainer.

With the above-described configuration, the first image obtainer is disposed outside the optical axis to obtain the first image, while the second image obtainer is disposed on the optical axis to obtain the second image.

In one of the first through fourth aspects, an output light adjusting device according to a seventh aspect of the disclosure may further include first and second light splitters that split the path of the second output light. The first image obtainer may be disposed at a position at which it is able to receive the second output light which is split off outside the optical axis by the first light splitter. The second image obtainer may be disposed at a position at which it is able to receive the second output light which is split off outside the optical axis by the second light splitter. The position of the first image obtainer may be a position at which a distance between the near position and a first split position, the first split position being a position at which the first light splitter splits the second output light, becomes equal to a distance between the first split position and the first image obtainer. The position of the second image obtainer may be a position at which a distance between the far position and a second split position, the second split position being a position at which the second light splitter splits the second output light, becomes equal to a distance between the second split position and the second image obtainer.

With the above-described configuration, the first image obtainer is disposed outside the optical axis to obtain the first image, while the second image obtainer is disposed outside the optical axis to obtain the second image.

In one of the first through seventh aspects, an output light adjusting device according to an eighth aspect of the disclosure may further include a comparator and an output light adjuster. The comparator compares a size of the first image and that of the second image with each other. The output light adjuster adjusts a position of an optical component of the light source module so that the comparator judges that a degree of matching between the size of the first image and that of the second image is included within a predetermined range.

With this configuration, the output light adjusting device is able to adjust the degree of collimation of the first output light to a desired degree of collimation.

In an output light adjusting device according to a ninth aspect of the disclosure, in one of the first through eighth aspects, the condenser may be an achromatic lens.

The functions of an achromatic lens have almost no wavelength dependency. In other words, an achromatic lens restricts chromatic dispersion. By using an achromatic lens as the condenser, the first and second image obtainers can be maintained at substantially fixed positions regardless of the wavelength of the first output light incident on the condenser. Even when light sources having different emission wavelengths are used, the output light adjusting device or an operator user can easily make adjustment to the first output light without changing the settings of the output light adjusting device.

An output light adjusting method according to a tenth aspect of the disclosure is an output light adjusting method for adjusting a degree of collimation of first output light emitted from a light source module. The light source module is a subject to be adjusted. The output light adjusting method includes: comparing a size of a first image of second output light and a size of a second image of the second output light with each other, the first image of the second output light being obtained at a position at which a length of a path of the second output light output from a condenser, the condenser receiving the first output light, matches a first distance, the first distance being a distance from the condenser to a near position, the second image of the second output light being obtained at a position at which the length of the path of the second output light output from the condenser matches a second distance, the second distance being a distance from the condenser to a far position; and adjusting a position of an optical component of the light source module so that a degree of matching between the size of the first image and the size of the second image is judged to be included within a predetermined range as a result of comparing the size of the first image and that of the second image. The near position is a position which is close to the condenser on an optical axis of the condenser and which is separated from a preset reference light-concentration position of the second output light by a predetermined distance. The far position is a position which is located at a side opposite the near position on the optical axis with the reference light-concentration position interposed therebetween and which is separated from the reference light-concentration position by a predetermined distance.

With the above-described configuration, the size of the first image and that of the second image obtained at the above-described positions are compared with each other, and based on a comparison result, the position of an optical component of the light source module is adjusted so that the degree of matching between the size of the first image and that of the second image is contained within the above-described predetermined range. It is thus possible to adjust the degree of collimation of the first output light. That is, the position of the optical component is adjusted based on the comparison result so that the shape of the first image and that of the second image substantially match each other. The degree of collimation of the first output light can thus be adjusted.

Therefore, with a simple method, the output light adjusting device or an operator user is able to speedily and highly precisely adjust the degree of collimation of the first output light emitted from a light source module, which is a subject to be adjusted, to a desired degree of collimation.

The present disclosure contain subject matter related to that disclosed in Japanese Priority Patent Application JP 2020-137568 filed in the Japan Patent Office on Aug. 17, 2020, the entire contents of which are hereby incorporated by reference.

### [Appendix]

While there have been described what are at present considered to be certain embodiments of the disclosure, it should be understood by those skilled in the art that various modifications, combinations, sub-combinations and alterations may occur depending on design requirements and other factors insofar as they are within the scope of the appended claims or the equivalents thereof.

What is claimed is:

1. An output light adjusting device for adjusting a degree of collimation of first output light emitted from a light source module or for making the degree of collimation of the first output light adjustable, the light source module being a subject to be adjusted, comprising:
a first image obtainer that obtains a first image of second output light output from a condenser, the condenser receiving the first output light, the first image being obtained at a position at which a length of a path of the second output light output from the condenser matches a first distance, the first distance being a distance from the condenser to a near position; and
a second image obtainer that obtains a second image of the second output light at a position at which the length of the path of the second output light output from the condenser matches a second distance, the second distance being a distance from the condenser to a far position,
wherein the near position is a position which is close to the condenser on an optical axis of the condenser and which is separated from a preset reference light-concentration position of the second output light by a predetermined distance, and
wherein the far position is a position which is located at a side opposite the near position on the optical axis with the reference light-concentration position interposed therebetween and which is separated from the reference light-concentration position by a predetermined distance.

2. The output light adjusting device according to claim 1, wherein the reference light-concentration position is a position of a focal point of the condenser.

3. The output light adjusting device according to claim 1, wherein the far position is a position located symmetrically to the near position with respect to the reference light-concentration position on the optical axis.

4. The output light adjusting device according to claim 1, wherein:
a profile indicating a size of an image of the second output light on a plane perpendicular to the optical axis is obtained in advance, the size of the image in the profile being indicated in accordance with a position of the second output light on the optical axis; and
an amount of change of the size of the image in the profile becomes different in accordance with a mode of the first output light, and the near position and the far position are set to be at or close to positions at which a difference in the amount of change of the size of the image according to the mode of the first output light is greater than or equal to a predetermined amount.

5. The output light adjusting device according to claim 1, wherein:
the second image obtainer is disposed at the far position; and
the first image obtainer is disposed at the near position at least when the first image obtainer obtains the first image of the second output light at the near position, and the first image obtainer is moved out of the optical axis when the second image obtainer obtains the second image of the second output light at the far position.

6. The output light adjusting device according to claim 1, further comprising:
a first light splitter that splits the path of the second output light, wherein
the second image obtainer is disposed at the far position,
the first image obtainer is disposed at a position at which the first image obtainer is able to receive the second output light which is split off to outside the optical axis by the first light splitter, and
the position of the first image obtainer is a position at which a distance between the near position and a first split position, the first split position being a position at which the first light splitter splits the second output light, becomes equal to a distance between the first split position and the first image obtainer.

7. The output light adjusting device according to claim 1, further comprising:
first and second light splitters that split the path of the second output light, wherein
the first image obtainer is disposed at a position at which the first image obtainer is able to receive the second output light which is split off outside the optical axis by the first light splitter,
the second image obtainer is disposed at a position at which the second image obtainer is able to receive the second output light which is split off outside the optical axis by the second light splitter,
the position of the first image obtainer is a position at which a distance between the near position and a first split position, the first split position being a position at which the first light splitter splits the second output light, becomes equal to a distance between the first split position and the first image obtainer, and
the position of the second image obtainer is a position at which a distance between the far position and a second split position, the second split position being a position at which the second light splitter splits the second output light, becomes equal to a distance between the second split position and the second image obtainer.

8. The output light adjusting device according to claim 1, further comprising:
a comparator that compares a size of the first image and a size of the second image with each other; and
an output light adjuster that adjusts a position of an optical component of the light source module so that the comparator judges that a degree of matching between the size of the first image and the size of the second image is included within a predetermined range.

9. The output light adjusting device according to claim 1, wherein the condenser is an achromatic lens.

10. An output light adjusting method for adjusting a degree of collimation of first output light emitted from a light source module, the light source module being a subject to be adjusted, comprising:
comparing a size of a first image of second output light and a size of a second image of the second output light with each other, the first image of the second output light being obtained at a position at which a length of a path of the second output light output from a condenser, the condenser receiving the first output light, matches a first distance, the first distance being a distance from the condenser to a near position, the second image of the second output light being obtained at a position at which the length of the path of the second output light output from the condenser matches a second distance, the second distance being a distance from the condenser to a far position; and
adjusting a position of an optical component of the light source module so that a degree of matching between the size of the first image and the size of the second image is judged to be included within a predetermined range as a result of comparing the size of the first image and the size of the second image,
wherein the near position is a position which is close to the condenser on an optical axis of the condenser and which is separated from a preset reference light-concentration position of the second output light by a predetermined distance, and
wherein the far position is a position which is located at a side opposite the near position on the optical axis with the reference light-concentration position interposed therebetween and which is separated from the reference light-concentration position by a predetermined distance.
